(19) United States
(12) Patent Application Publication
(10) Pub. No.: US 2010/0332158 A1
(43) Pub. Date: Dec. 30, 2010

(54) METHOD FOR MEASURING DISPENSED VOLUME OF A LIQUID IN A CONTAINER BY MEASURING CAPACITANCE

(75) Inventors: Olivier Courtial, Lyon (FR); Dominique Decaux, Chaponost (FR); Lionel Majczak, Chazay d'Azergues (FR)

Correspondence Address: OLIFF & BERRIDGE, PLC, P.O. BOX 320850, ALEXANDRIA, VA, 22320-4850, US

(73) Assignee: BIOMÉRIEUX, Marcy L'etoile (FR)

(21) Appl. No.: 12/918,157

(22) PCT Filed: Mar. 17, 2009
(86) PCT No.: PCT/FR2009/050432

§ 371 Date: Aug. 18, 2010

(30) Foreign Application Priority Data
Mar. 17, 2008 (FR) 0851709

(51) Int. Cl. G01F 13/00

(52) U.S. Cl. 702/55

(57) ABSTRACT

A method for measuring the volume of a liquid dispensed inside a container with the aid of a suction/discharge device included in an analysis automaton,
said method comprising:
positioning said suction/discharge device plumb with said container;
triggering the continuous measurement of the values of electrical capacitance between the end of the needle of the suction/discharge device and the assembly consisting of the container, the chassis of the analysis automaton;
triggering the dispensing of the liquid into the container with the aid of the suction/discharge device;
measuring the period t during which the values of electrical capacitance between the end of the needle of the suction/discharge device and the assembly are greater than a threshold value S; and
calculating the volume of liquid dispensed into the container.

The present invention pertains to biological analysis automatons. More specifically, the present invention deals with a method for measuring the volume of a liquid dispensed in an analysis container by measuring capacitance.

In automated devices for biological analyses or analysis automatons, the determination of the quantity of liquid dispensed into the analysis containers is fundamental in order to be certain of the relevance of the results obtained. Indeed, at each step of the analysis it is necessary to measure the volume of liquid dispensed into the container, but also to be certain of the presence of the liquids of interest in said container. This is the case not only with the biological sample to be analyzed, but also with the reagents and the washing solutions used in the course of the analysis. This problem of volumetry management therefore comes more generally under the heading of quality aimed not only at improving the results delivered by such analysis automatons, but also at enhancing the reliability of said results. Indeed, the reliability and repeatability of the results obtained depend on the accuracy and repeatability of the dispensed volumes.

Such obligations are moreover dictated by the implementing of tighter regulations and especially the CE IVD (In Vitro Diagnostic) standard in force since the month of December 2003.

Devices employing methods for measuring the volume of liquid in containers, particularly containers of the reaction cup type, have already been described.

Certain devices are based on indirect measurement of the liquid volume. This occurs particularly in analysis automatons that do not use any stream of liquid; stated otherwise, automatons for which fluidic management is performed by means of a pneumatic device. In this case, it is possible to control the pressure of the air contained in the fluidic management circuit. Thus, the modification of the pressure profile of the air situated between the suction syringe and the liquid being withdrawn or dispensed occurring in the needle, makes it possible to evaluate the volume of liquid withdrawn or dispensed.

This indirect measurement technique is possible by virtue of the compressibility properties of air. It turns out to be impossible to implement with an analysis automaton in which the system for managing the liquids is based on the use of a stream of liquid, since liquids are incompressible.

Rather than volume measurement as such, other automatons use the measurement of liquid level in the container after dispensing to deduce therefrom the liquid volume dispensed.

Thus, a first type of device consists in optical devices, of the emitter—receiver type, which measure the liquid level through the wall of the container by altering the difference in refractive index between air and a liquid.

The drawback of devices and methods of this type is that they can be employed only with translucent containers. Now, biological analysis automatons regularly make use of chemoluminescence-based revelation means which involve carrying out detection in total darkness. Consequently, the use of opaque containers is compulsory, making it impossible to employ such volume-measuring tools.

Other optical devices also use the difference in refractive index between air and liquids to measure the level or volume of liquid in a container. However, unlike the devices cited above, the latter are invasive. Indeed, the emitter which is generally an optical fiber comes into contact with the liquid. This leads to a modification of the refraction of the incident beam and therefore to a modification of the emergent beam, indicating to the device that it has come into contact with the liquid. Such a device is described for example in U.S. Pat. No. 4,809,551.

The major drawback of such a method based on the difference in refraction between air and liquids is that it is implemented by means of a device exhibiting the drawback of coming into contact with the liquid, this being unacceptable when this liquid is a biological sample. Indeed, the same device being used to measure the liquid level in several containers with different samples, the risk of contamination between samples is considerably increased, even after steps of washing the withdrawal needle.

Document U.S. Pat. No. 5,194,747 discloses a device for measuring liquid level by way of optical means consisting essentially in the use of a laser diode emitting an incident light beam by way of an optical fiber and then of an optical transmitter, said beam being reflected by the surface of the liquid so that the emergent beam is received by a photoreceptor. A phase detector then measures the phase difference between the incident beam and the emergent beam. A counting scale makes it possible to correlate the phase difference value with the level of the liquid in the container.

The device described in document U.S. Pat. No. 5,194,747 exhibits the major drawback of being secured to the container in which the measurement of level is carried out, especially through the fact that part of the device is integrated into the upper wall of the container or secured to the wall with the aid of screws. Such an arrangement therefore makes it impossible to implement a method for measuring the level of the liquid, in a high-flowrate analysis automaton carrying out batch analyses on several mutually independent single-use containers.

Another major drawback of this device is its complexity which, on the one hand, makes its retail cost high and, on the other hand, prevents it being fitted on existing automatons.

Other devices are based on the principle of weighing the container. Indeed, by performing a differential weighing of the container, the analysis automaton determines whether the container has been filled or emptied and can optionally determine the liquid volume present in the container.

However, this type of weighing device, though it is sufficiently efficacious when the containers are used individually, provides rather inaccurate information for containers arranged in a rack, that is to say inter-related. In this case, the value obtained can only be a mean value over the assembly of containers, thus excluding any accurate measurement on each of the containers.

Another type of device is based on magnetic properties. Such a device is described for example in the document EP-A-1 014 049. Said device comprises an electromagnet for the contactless excitation of a wall of the receptacle with an attenuated mechanical oscillation and a probe for the contactless determination of the oscillation related to the liquid level contained in the receptacle. The liquid level is determined by the level of attenuation of the oscillation.

Such a device exhibits the drawback of having to be used with metal containers in order to ensure the electromagnetization phenomena. Now, both for health risk and for cost reasons, containers used nowadays are generally made of plastic so as to be replaced regularly, or indeed to be single-use.

The method implemented with this device is therefore inappropriate to the use of such containers.

Another type of device consists of ultrasound-based measuring devices. Devices of this type exhibit the advantage of being able to accurately measure the liquid level in a container. On the other hand, in addition to their high cost, these devices are generally fairly complex and cumbersome. They require, moreover, reproducible coupling between the ultrasound probe and the cup, so as to accurately determine the volume present in the cup by measuring the round trip flight time of the ultrasound wave. This therefore makes fitting on an existing automaton very difficult.

Another type of device consists of devices intended to measure the liquid level in a container by capacitive measurement. Indeed, the variation of the capacitance between the needle of the device and the container makes it possible to detect the contacting of the end of the needle with the surface of the liquid. This method is based on the fact that the capacitance value increases as the needle approaches the liquid, up to a maximum value corresponding to a position where the needle is dipped in the liquid. Device and method are described for example in document U.S. Pat. No. 4,818,491.

Though they are particularly fitting for the measurement of the level of a liquid present in a container, they are not on the other hand at all suitable for measuring the volume of a liquid dispensed into a container, Conversely, a method for measuring the liquid volume during dispensing may turn out to be necessary in order to confirm that the quantity of liquid withdrawn is in fact right. Indeed, it is not rare with this type of level-detecting device to have withdrawal errors due to errors in the determination of the level. Indeed, when bubbles are present at the surface of the liquid to be withdrawn, it can happen that the device considers the bubbles to be the surface of the liquid. The device therefore comes to a halt and commences the withdrawing, by sucking up the bubbles, thus falsifying the quantity of liquid withdrawn.

Finally, a last type of device is that described in document EP-1 568 415 A2. This document describes a device and a method for measuring the volume of droplets dispensed by a nozzle of a system for dispensing droplets, by measuring the variation in capacitance. This measurement is based essentially on the breaking of fluidic contact between the droplet and the end of the nozzle, this breaking of fluidic contact inducing a detectable voltage variation.

A significant drawback of the droplet volume measuring device described in document EP-1 568 415 A2 is that, on account of its excessively great sensitivity necessary for measuring excessively low volume, it requires an excessively stable electrical environment, obtained in particular by installing a Faraday cage. Now, such a construction is utterly inconceivable within a biological analysis automaton, which exhibits a changing electrical environment, on account of the use of a container conveying system; on account of the fact that the containers may perhaps contain different volumes of liquids, prior to the dispensing of the liquid which forms the subject of the volume measurement; on account of the fact that the electrochemical nature of the liquids used in such automatons varies significantly, consequently modifying the electrical environment in which the volume measurement is carried out.

Such a device, though it is very effective, also exhibits the drawback of being essentially suitable for measuring droplets whose volume is relatively low, of the order of a picoliter or nanoliter. Indeed, in order that the measurement scheme described in document EP-1 568 415 A2 can be implemented, it is compulsory that a fluidic break occurs between the droplet and the dispensing nozzle. Stated otherwise, it is compulsory that the droplet is isolated in space, both from the dispensing device and from the container which will receive it. This necessity implies that such a device is absolutely not suitable for measurements of liquid volumes, such as those implemented within biological analysis automatons, which range from several tens of microliters to a few milliliters. Indeed, such volumes are dispensed in the form of a stream of liquid, which ensures fluidic continuity between the nozzle of the liquid dispensing system and the container receiving the liquid. To obtain an isolated segment of liquid exhibiting a volume such as those described above, it would be necessary to have a nozzle with a much higher diameter or else to position the nozzle at a large distance from the container, incompatible with the size of analysis automatons.

Finally, such a system is not very suited to the use of racks or plastic cups, exhibiting insulating properties.

It therefore follows that, to date, there is no effective method for measuring variable volumes of liquids dispensed in individual or collective containers, whether transparent or opaque, that is not contingent on a stable electrical environment and can be implemented by means of an existing device or that may be easily fitted on existing analysis automatons, at a limited cost.

An objective of the present invention is therefore to provide an effective and robust method for measuring variable volumes of liquids, in particular of biological samples, dispensed into a container.

Another objective of the present invention is to provide a method for measuring the volume of a liquid dispensed into a container, which is able to identify the presence of bubbles in the liquid, thus falsifying the dispensed volume.

Another objective of the present invention is to provide a method for measuring the volume of a liquid dispensed into a container, making it possible to perform measurements without lengthening the sample dispensing time.

Another objective of the present invention is to provide a method for measuring the volume of a liquid dispensed into a container, making it possible to measure the volume of several liquid segments intended to be dispensed in one and the same dispensing cycle.

Another objective of the present invention is to provide a method for measuring the volume of a liquid dispensed into a container, making it possible to discriminate, prior to the dispensing, empty containers from partially filled containers.

These objectives, among others, are achieved by the present invention which relates, firstly, to a method for measuring the volume of a liquid dispensed inside a container with the aid of a suction/discharge device included in an analysis automaton, said method comprising the following steps:
a) Positioning said suction/discharge device plumb with said container, at a distance d from the bottom of the container or from the surface of the liquid present in the container;
b) Triggering the continuous measurement of the values of electrical capacitance between the end of the needle of the suction/discharge device and the assembly consisting of the container, the chassis of the analysis automaton and optionally the liquid present in the container; said value being considered to be the base value B;
c) Triggering the dispensing of the liquid into the container with the aid of the suction/discharge device, so that the container and the needle of the suction/discharge device are in fluidic connection throughout the dispensing;
d) Measuring the period t during which the values of electrical capacitance between the end of the needle of the suction/discharge device and the assembly consisting of the container, the chassis of the analysis automaton and optionally the liquid present in the container are greater than a threshold value S; and
e) Calculating the volume of liquid dispensed into the container by multiplying the value of the period t obtained in step d) by the liquid dispensing flowrate of the suction/discharge device.

The expression “fluidic connection” is understood to mean that the needle of the suction/discharge device and the container are linked by a fluidic stream or column, formed by the discharging of the liquid from the suction/discharge device, into the container. Stated otherwise, the liquid dispensing must be regular and continuous, so that the dispensed liquid column forms the link between the free end of the needle of the suction/discharge device and the container receiving the liquid or the liquid already contained in the container. The concept of fluidic connection must not be interpreted as a possibility that the free end of the needle of the suction/discharge device dips into the liquid previously in the container or just poured into it.

According to a preferential embodiment, the method according to the invention comprises an additional step c′), subsequent to step c), consisting in moving the suction/discharge device along a vertical axis so as to maintain the distance d between the end of the needle and the surface of the liquid during dispensing.

Advantageously, the value of d is dependent on the liquid volume to be dispensed into the container. In particular, the value of d is determined so as to ensure that the time during which the needle of the suction/discharge device and the container are in fluidic connection is as long as possible.

According to a first variant of the method according to the invention, the value of the flowrate is a single mean value.

According to another variant of the method according to the invention, the value of the flowrate is a value that can vary over the time period t. In particular the value of the flowrate used is the effective value of the flowrate at each capacitance measurement. The suction/discharge device acceleration and deceleration ramps are thus taken into account.

According to an advantageous embodiment, the method according to the invention furthermore comprises an additional step occurring after step b) consisting in determining, prior to the dispensing, whether the container contains a residual liquid volume.

More particularly, the base value is compared with a reference value corresponding to the value of capacitance between the end of the needle of the suction/discharge device and the assembly consisting of the container empty of any liquid and the chassis of the analysis automaton.

The aims and advantages of the present invention will be better understood in the light of the detailed description which follows, given with reference to the drawing in which:

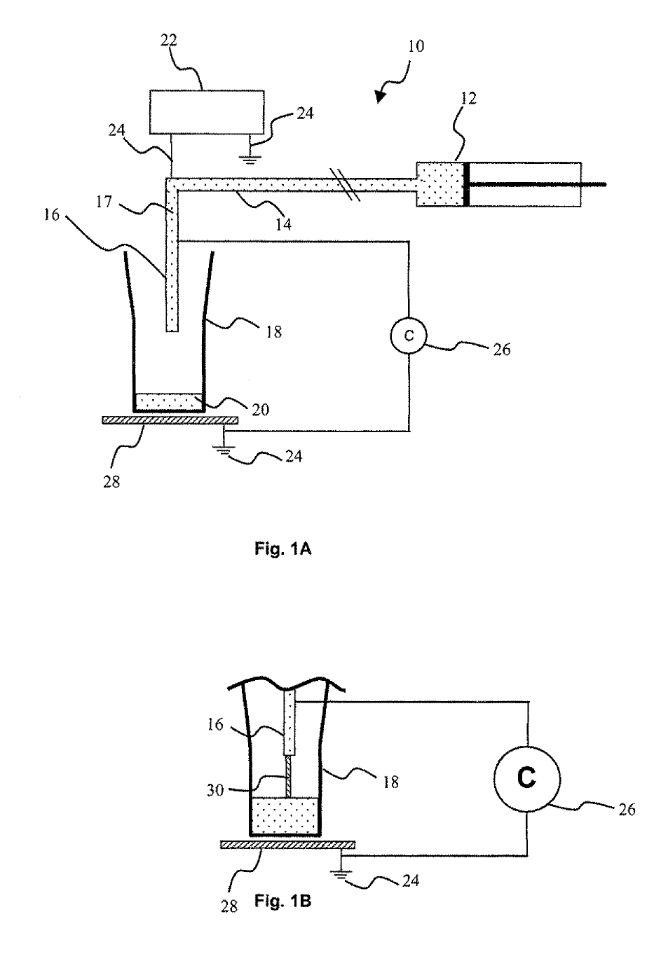

FIGS. 1A and 1B represent a schematic view of the system making it possible to implement the method according to the invention.

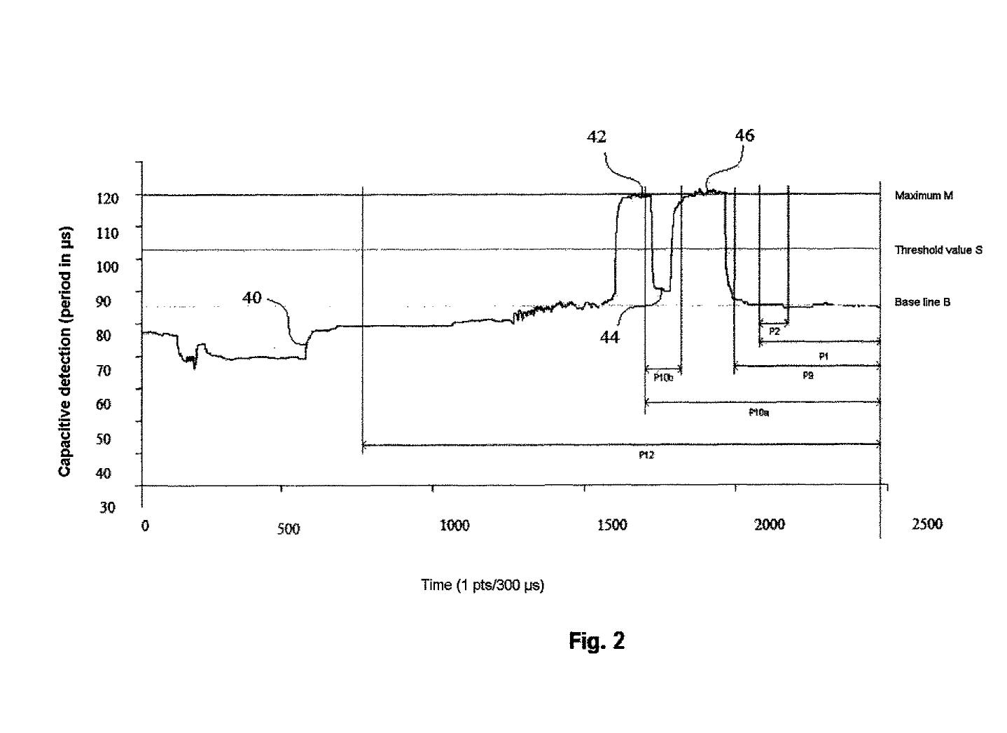

FIG. 2 represents a graph showing the capacitive detection over time, while dispensing two liquid volumes.

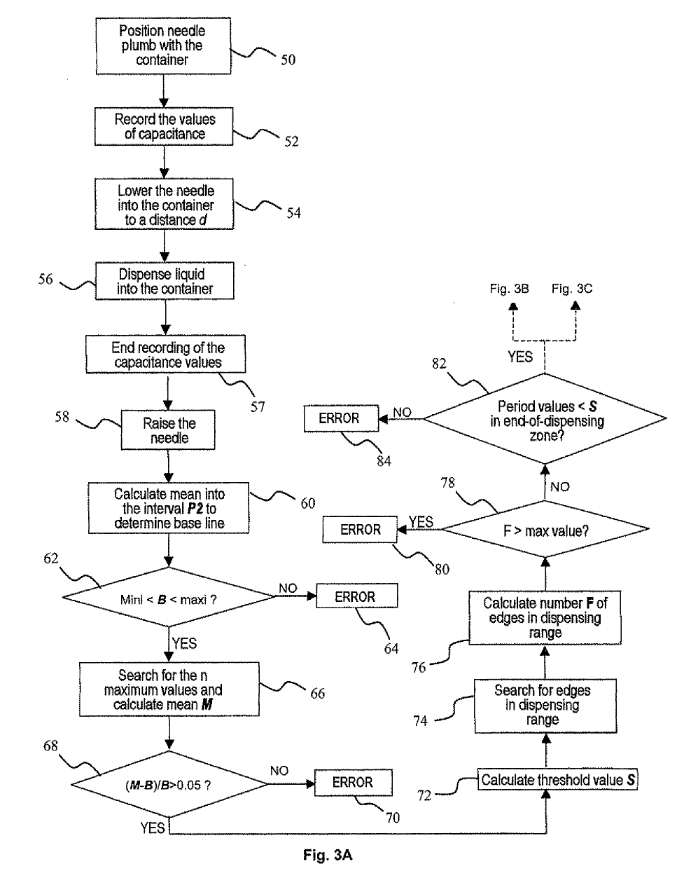

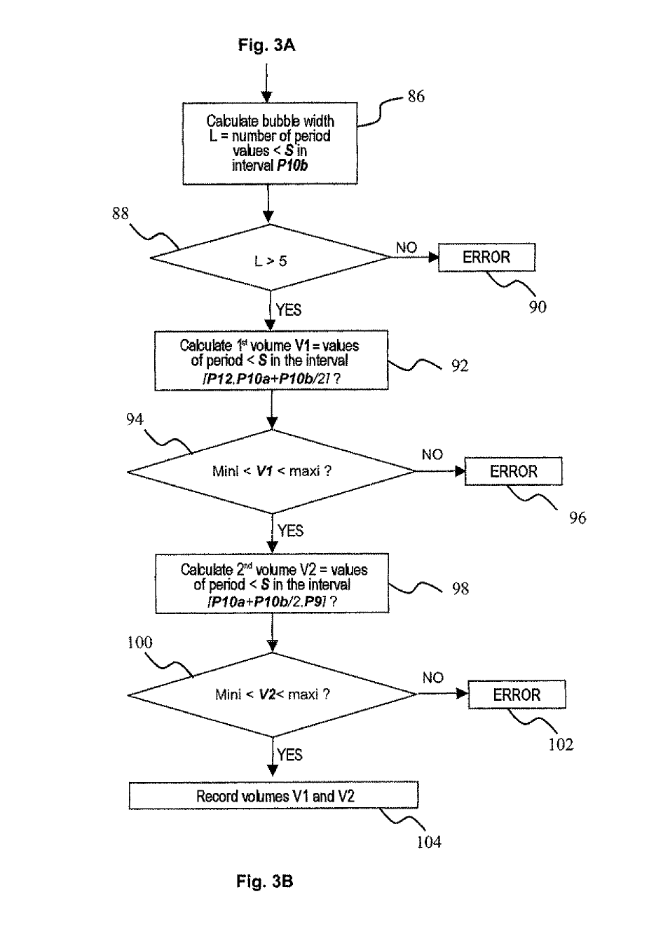

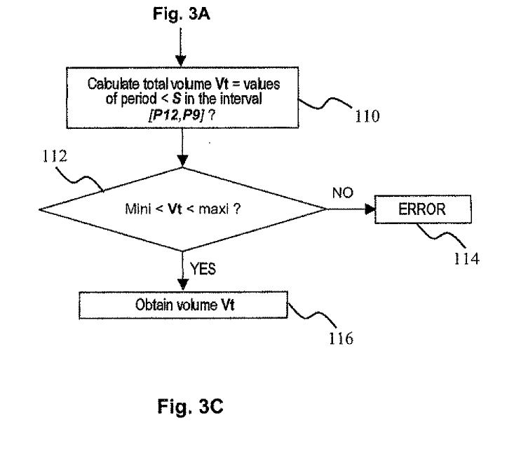

FIGS. 3A, 3B and 3C represent a flowchart of the method for measuring the volume of liquid dispensed into a container, according to two different embodiments.

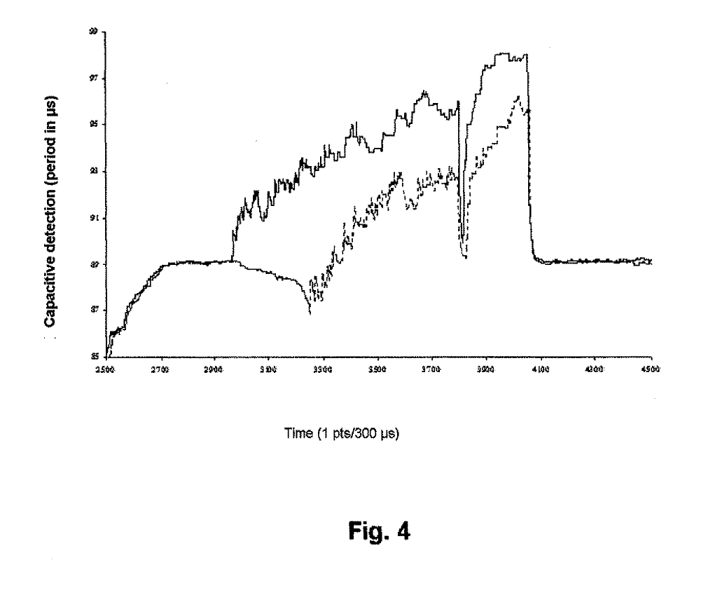

FIG. 4 represents a graph showing the influence on the capacitive detection of the presence of a residual liquid volume in the container before dispensing.

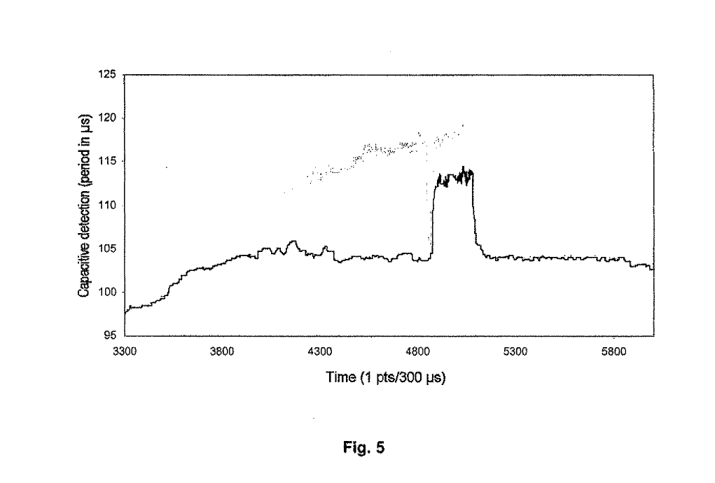

FIG. 5 represents a graph showing the discrimination between the dispensing of a first volume of 150 μl of liquid (water) and the dispensing of a first volume of 150 μl of air.

The system making it possible to implement the method according to the invention is represented in FIG. 1A. This system comprises firstly a suction/discharge device 10. This suction device is that conventionally used in an analysis automaton. In the present case, the analysis automaton considered is an immunoanalysis automaton, such as that marketed by the applicant under the brand VIDIA®. The suction/discharge device 10 consists principally of a dispensing syringe 12 linked fluidically to a dispensing needle 16, by means of a line 14. The dispensing needle 16 is positioned plumb with a container 18 into which the liquid 17 of interest is to be dispensed. This liquid of interest 17 may be a sample to be analyzed. It may also be an analysis reagent or else a washing liquid. Moreover, the container 18 may or may not contain a residual liquid. In this instance, it contains a residual liquid 20. Such a residual liquid may for example consist of the sample to be analyzed. In case, the dispensed liquid may be an analysis reagent.

Moreover, the dispensing needle 16 is linked in series to a capacitive level detecting device 22, comprising an electrical resistor R. The capacitive level detecting device 22 is for its part earthed 24.

The device 22 utilizes an oscillator of RC type comprising the resistor R and a capacitor C, referenced 26, whose first plate is constituted by the needle 16, the liquid 17 and the liquid 20 during dispensing, and whose second plate is constituted by the chassis 28 of the analysis automaton, earthed 24. The dielectric is constituted either by air outside of the period of dispensing the liquid 17 and the container 18, or by the liquid 17 during dispensing and the container 18. It follows that the oscillation frequency of the RC oscillator is directly dependent on the value of the capacitor 26. On the basis of the frequency, it is possible to obtain the value of the period t in microseconds (μs).

The principle of the method according to the invention is then as follows:
in the absence of fluidic connection between the dispensing needle 16 and the assembly consisting of the container 18 and liquid 20, the measured capacitance 26 is that of the air. The value of this capacitance is by definition relatively low (of the order of a picofarad (pF)).
during the dispensing of the liquid into the container by means of the suction/discharge device, physical contact is established by fluidic connection between the dispensing needle 16 and the container 18, liquid 20 assembly. This is observed schematically in FIG. 1B, in which the fluidic connection is depicted by a liquid jet 30 flowing from the end of the dispensing needle inside the container 18. The value of the capacitance 26 measured is then higher (a few pF). The oscillation frequency of the RC oscillator is also lower and therefore the value of the period t is higher.

The use of a dispensing needle of known diameter and a suitable dispensing rate makes it possible to obtain a cylindrical jet of near-constant diameter, close to the internal diameter of the dispensing needle. It is then possible to accurately estimate a mean flowrate, dependent on the diameter of the needle and the speed of the syringe of the suction/discharge device.

It follows that by measuring the variations of the period t over time and in particular the time for which the period t is greater than a predetermined threshold value, it is possible to determine the duration for which the dispensing needle 16 is in fluidic connection with the container 18, liquid 20, chassis 28 assembly, namely the duration for which the liquid, withdrawn by the suction/discharge device, is dispensed into the container. With an accurate knowledge of the dispensing flowrate of the suction/discharge device, it is then possible to calculate the liquid volume dispensed.

FIG. 2 represents a graph of capacitive detection showing the trend over time, of the period obtained on the basis of the measurement of the capacitance 26 by the capacitive level detecting device 22. It should be noted that the abscissa axis does not represent the time in intrinsic values but in terms of the number of measurement samples, for example every 300 μs. Moreover, the 0 value of the abscissa axis is situated to the right.

The first identifiable event on the graph is referenced 40. Indeed, whereas the value of the period is stable, a sudden increase in the latter is observed. This increase reflects the descent of the dispensing needle into the container. Indeed, as explained above, during a step of dispensing liquid into a container, the needle positions itself plumb with the container, and then performs a motion of descent into the container. As the needle descends into the container, the measured capacitance 26 increases on approaching the assembly consisting of the container 18, liquid 20, chassis 28 and earth 26. This increase in the capacitance 32 brings about a reduction in the oscillation frequency of the RC circuit and therefore an increase in the period t, such as observed on the graph.

The second notable event on this graph is an increase in the period t in the form of a peak referenced 42. This peak comprises a plateau and manifests the dispensing of the liquid, typically the sample inside the container. As explained above, during the dispensing of the sample a cylindrical jet of liquid forms, creating physical contact between the needle and the container and causing a significant increase in the measured capacitance 26. This increase is manifested as a significant increase in the period t.

The third notable event corresponding to the return to a base value of the period t, referenced 44, doing so before a new peak. In fact this fleeting reduction in the period t manifests the presence, in the dispensing circuit of the suction/discharge device, of an air bubble causing a fleeting cutting of the fluidic connection between the needle and the container, when the liquid is expelled from the needle. The role of this bubble is in fact to separate the sample volume from a second volume of liquid which, in this instance, is washing liquid.

The dispensing of the washing liquid is moreover clearly represented on the graph by the second peak 46.

The width of the peaks is directly correlated with the liquid volume dispensed. Indeed, the larger the liquid volume, the greater the time for which the fluidic connection (or physical contact) between the needle and the container lasts, this being manifested as a greater duration for which the period t is maintained at its high value. It follows that it is possible to deduce directly from observation of the graph that the volume of washing liquid dispensed into the container is greater than the sample volume dispensed previously.

The data analysis is carried out once the dispensing of the liquid has finished. This analysis is based on the values of the period t recorded as a function of time.

Thus, the parameters of the data analysis are also taken into account and depicted in FIG. 2. In particular, the base line B, the threshold value S and the maximum value M are defined on the graph.

The base line B is calculated after analysis of a certain number of measurement points constituting the interval P2, also defined on the graph of FIG. 2. For example, 120 consecutive measurement points of the interval P2 are taken into account and the mean of these 120 points constitutes the value of the base line 13.

The maximum value M is calculated by taking into account several maximum values.

The number of measurement points used to calculate the maximum value M must be sufficiently large to ensure that a high value is not due to an artifact. Nonetheless, it must not be too large so as not to exceed the total duration of a plateau. Thus, it is reasonable to calculate the maximum value M by calculating, for example, the mean of 120 measurement points.

The threshold value S is, for its part, determined mathematically since it is equal to 40% of the difference between the maximum value M and the value of the base line B. The threshold value S is the value of the period t from which it is considered that the fluidic connection is actually established.

The other parameters identifiable on the graph of FIG. 2 are the various intervals used to perform the data analysis.

Thus, the value P1 is the value constituting the start of the base line B calculation zone. This value is here situated at the end of the liquid dispensing phase since it is a period during which the analysis automaton has paused before commencing the next step of the analysis. This period is then apt for calculating the value of the threshold line. For example, the value of P1 may consist of the 200^{th} measurement point before the end of the recording of capacitance values. In the case where a measurement is carried out every 300 μs, the value P1 is therefore situated 60 milliseconds (ms) before the end of the recording of capacitance values.

The interval P2 is the interval corresponding to the 120 consecutive measurement points of the period t for calculating the base line B, one of the bounds of this interval consisting of the value P1.

The value P12 is the value constituting the start of the interval of the dispensing range. For example, the value of P1 may consist of the 2000^{th} measurement point before the end of the recording of capacitance values. In the case where a measurement is carried out every 300 μs, the value P12 is therefore situated 600 milliseconds (ms) before the end of the recording of capacitance values.

The value P9 is the value constituting the start of the end-of-dispensing zone. In this zone, the measured values of the period t must systematically be less than the threshold value S. In the converse case, an error is triggered by the analysis automaton. For example, the value of P9 may consist of the 300^{th} measurement point before the end of the recording of capacitance values. In the case where a measurement is carried out every 300 μs, the value P9 is therefore situated 90 milliseconds (ms) before the end of the recording of capacitance values.

The value P10a is the value corresponding to the start of the search interval for the separation bubble when the latter is presumed to be present. For example, the value of P10a may consist of the 800^{th} measurement point before the end of the recording of capacitance values. In the case where a measurement is carried out every 300 μs, the value P10a is therefore situated 240 milliseconds (ms) before the end of the recording of capacitance values. Once this measurement point value has been reached, the bubble is expected to be detected.

The interval P10b is the interval corresponding to the consecutive measurement points used to evidence a consecutive reduction of several values of the period t corresponding to the presence of the separation bubble. This interval can for example consist of 180 consecutive measurement points.

FIG. 3 shows the flowchart of the method of dispensing liquid, of data analysis and of calculating the volume of liquid dispensed into a container by the suction/discharge device. Such a method is implemented on the VIDIA® immunoanalysis automaton marketed by the applicant. It should be noted that the process for withdrawing the liquid to be dispensed, whether it be the sample or a reagent, is not described here. Firstly, the needle is positioned plumb with the container in which the liquid is to be dispensed. This consists of step 50. Thereafter, the process for acquiring and recording the capacitance values by way of the capacitive level detecting device is engaged, in accordance with step 52. The needle then begins its descent inside the container until its end lies a distance d from the surface of the liquid. The distance d is dependent on the liquid volume to be dispensed into the container. It is the system which determines this distance as a function of the volume which is to be dispensed. This is carried out in step 54. Step 56 consists in the actual dispensing of the liquid into the container. Once dispensing has been completed, the process of acquiring and recording the capacitance values stops, in step 57. The needle then goes back to its initial position outside the container, plumb with the latter, in accordance with step 58.

According to a variant of the method according to the invention, steps 56 and 58 can take place simultaneously. Stated otherwise, the needle rises as the liquid is dispensed into the container. This variant in fact corresponds to dynamic management of dispensing. The benefit of such management will be explained below, in relation to FIG. 4.

Once the liquid dispensing has been performed, data analysis commences. In particular, in step 60, the value of the base line B is calculated in the interval P2, such as described above.

Once the value of the base line B has been calculated, it is compared with a minimum value and a maximum value, both previously determined and recorded in the memory of the analysis automaton. These values are for example 80 μs for the minimum value and 110 μs for the maximum value. If the value of B does not lie between the minimum value and the maximum value, the analysis automaton displays an error, in accordance with step 64. If the value B does actually lie between the minimum value and the maximum value, the next step of the data analysis is undertaken.

The next step 66 consists in searching for the 120 maximum values in the dispensing range, namely between the value P12 and the stopping of the recording of capacitance values, for the calculation of the maximum value M, as explained above. Thus, the 120 largest recorded values of the period t are retained and the mean value is calculated. This value constitutes the maximum value M.

Once the maximum value M has been calculated, the algorithm of the analysis automaton compares the value of the base line B and the maximum value M, in step 68. In particular, it calculates the ratio between the value of the difference between M and B, and the value B. If the value of this ratio is less than 0.05 (i.e. 5%), tolerated minimum discrepancy between M and B, the analysis automaton displays an error, in accordance with step 70. Indeed, a difference of less than 5% denotes an anomaly in the liquid dispensing or data acquisition method. If the difference between B and M is greater than 5%, the calculation of the threshold value S is carried out in step 72.

The next step 74 consists in looking for the edges in the dispensing range, namely between the value P12 and the stopping of the recording of capacitance values. The term “edges” is understood to mean the crossing of the threshold value S by the time period t, that is to say when the period t passes from a value below the threshold value S to a value above or vice versa Once all the edges have been identified, they are reckoned up in step 76 so as to define the number of edges F.

In step 78, the number of edges F is compared with the value of the maximum number of edges. If the number F is greater than the maximum value, the analysis automaton displays an error, in accordance with step 80. Indeed, too large a number of edges may signify that the suction/discharge device has sucked up and dispensed foam, in which case the volume of liquid dispensed does not correspond to the expected volume. The maximum value of the number of edges depends on the type of liquid and the number of segments of liquid dispensed into a container. Indeed, it is known through experience, that certain samples are more apt than others to foam. Moreover, it is obvious that if it is envisaged that several liquids are to be dispensed into one and the same container in one and the same dispensing step, by way of several liquid segments separated by an air bubble, it is expected that a larger number of edges will be detected.

If the number of edges is less than the maximum value, a check is conducted in the end-of-dispensing zone, namely between the value P9 and the stopping of the recording of capacitance values, to verify that there are no values of the period t which are greater than the threshold value S. The aim of this step is to confirm that the dispensing of the liquid has indeed been completed, which must be the case in the end-of-dispensing zone, and that this is clearly apparent in regard to the values of the period t. If this is not the case, the analysis automaton displays an error, in accordance with step 84.

According to a first embodiment represented in FIG. 3B, the next step 86 consists in calculating the width of the separation bubble L. For this purpose, it is of course necessary, as determined by the analysis protocol, to expect to find a bubble. In order to calculate the width of the bubble L, it is appropriate to reckon up the number of consecutive values of the period t which are less than the threshold value S, in the interval P10b.

Once the number L has been calculated, it is compared in step 88 with the reference number corresponding to the minimum number defining the separation bubble. The minimum number of values of the period t that are less than S is fixed at 5 here. Nonetheless, this number depends on the size of the separation bubble that one is expecting to identify, the size of the bubble being dependent on the analysis protocol implemented on the automaton.

If the number L is less than 5, the analysis automaton displays an error, in accordance with step 90. This in fact signifies that the expected bubble has not been found.

If the number L complies with what was expected, then the liquid volumes are calculated.

The first volume V1 of the liquid dispensed before the separation bubble is calculated in step 92, by determining the number of values of the period t that are greater than the threshold value S, in the interval lying between the value P12 and the value P10a+P10b/2. As explained above, to calculate the volume it is necessary to reckon up the total time of the values of the period t that are greater than the threshold value S. This time is thereafter multiplied with the dispensing flowrate of the needle, so as to obtain the volume.

In step 94, a check is conducted to verify that the volume V1 obtained accords with the minimum and maximum tolerance values. If such is not the case, the analysis automaton displays an error, in accordance with step 96.

If such is the case, the next step 98 consists in calculating the second volume V2 of the liquid which was dispensed after the separation bubble. This volume V2 is by determining the number of values of the period t that are greater than the threshold value S, in the interval lying between the value P10a+P10b/2 and the value P9.

In step 100, a check is conducted to verify that the volume V2 obtained is in accord with the minimum and maximum tolerance values. If such is not the case, the analysis automaton displays an error, in accordance with step 102.

If such is the case, the value of the volumes V1 and V2 is recorded in step 104 in the analysis automaton, which is then ready to undertake the next step of the analysis protocol.

A second embodiment is represented in FIG. 3C. This mode corresponds to the case where no separation bubble is dispensed. Stated otherwise, a single segment of liquid is dispensed into the container. In this case, step 110 consists in calculating the total volume Vt of the liquid which has been dispensed into the container, by determining the number of values of the period t that are greater than the threshold value S, in the interval lying between the values P12 and P9.

In step 112, a check is conducted to verify that the volume Vt obtained is in accord with the minimum and maximum tolerance values. If such is not the case, the analysis automaton displays an error, in accordance with step 114.

If such is the case, the value of the volume Vt is recorded in step 116 in the analysis automaton, which is then ready to undertake the next step of the analysis protocol.

According to a preferential embodiment, it is beneficial to have a mode of dynamic management of dispensing. Indeed, in the case of static or conventional management of dispensing, the needle is positioned in the container so that its end is situated a distance d from the surface of the liquid and no longer moves until it emerges from the container. This mode of operation can exhibit drawbacks in two specific cases. The first case is that in which the distance d is too large in regard to the quantity of liquid to be dispensed. It follows that all the liquid will be dispensed in the form of a segment of liquid, whose length will be less than the distance d. In this case, the needle and the container are not in fluidic connection or physical contact, since the liquid segment, once dispensed, continues in its fall during a spell of time in contact, neither with the needle, nor with the container. The capacitance variation is then nonexistent and it is therefore impossible to measure the volume dispensed.

In the second case, the distance d is too small in regard to the quantity of liquid to be dispensed. It follows that once all the liquid has been dispensed, the end of the needle will dip into the liquid contained in the container. In this case, there will indeed be an increase in capacitance due to the fluidic connection created between the needle and the container. Nonetheless, because the needle ultimately dips into the dispensed liquid, the fluidic connection is not broken and therefore there is no decrease in the capacitance. It is therefore also impossible to measure the volume dispensed.

The use of dynamic management of dispensing makes it possible to avoid these drawbacks. Indeed, said management consists in positioning the end of the needle sufficiently near the liquid to obtain an optimized distance d, namely a distance such that the fluidic connection between the needle and the container is established as quickly as possible once dispensing has been initiated. The needle rises in a linear manner as dispensing proceeds, so as to ensure the breaking of the fluidic connection at the end of dispensing.

FIG. 4 relates to a graph showing the influence on the capacitive detection of a residual liquid volume present in the container before dispensing. The residual volume is here 77 μl. In the absence of a residual liquid volume (dotted curve), the value of the period increases as the needle descends into the container, as explained above. On the other hand, in the presence of a residual liquid volume (solid curve), the period increases sooner. The method according to the invention therefore makes it possible to verify, if not quantitatively at least qualitatively, the presence or the absence of a residual liquid volume in the container before dispensing.

FIG. 5 relates for its part to a graph showing the discrimination between the dispensing of a first volume of 150 μl of liquid (water) and the dispensing of a first volume of 150 μl of air. This dispensing is followed by a dispensing of a volume of 30 μl of second liquid, which is a washing solution. The solid curve shows the dispensing of the air. The increase in the period between 3500 and 4000 measurement points, corresponding to the descent of the needle into the container, is firstly noted. The value of the period then remains stable until the 30 μl of washing solution are dispensed. On the dotted curve, a similar increase in the period between 3500 and 4000 measurement points, corresponding to the descent of the needle into the container, is observed. An additional peak corresponding to the dispensing of the 150 μl of water is moreover observed. This peak is followed by a steep fall corresponding to the dispensing of the separation bubble, and then by a second peak corresponding to the 30 μl of washing solution. The two washing solution peaks are totally superimposed thereby confirming the reproducibility of the dispensing. Moreover, when the width of the first and second peaks is measured, it is noted that the width of the first peak is about 5 times as large as that of the second peak, this correlating well with the ratio between the two volumes (water and washing solution) dispensed. The calculation of the overall volume dispensed on the basis of the method according to the invention has made it possible to obtain a volume of 179 μl+/−2 μl, for an expected volume of 180 μl (150+30 μl).

The method according to the invention therefore makes it possible to measure in a relatively accurate and reliable manner the volume of the liquids dispensed by the suction/discharge device of an analysis automaton, inside a container. Moreover, this method may be very easily implemented in an analysis automaton possessing a system for capacitive detection of the level of liquid to be withdrawn.

1. A method for measuring the volume of a liquid dispensed inside a container with the aid of a suction/discharge device included in an analysis automaton, said method comprising the following steps:
a) Positioning said suction/discharge device plumb with said container, at a distance d from the bottom of the container or from the surface of the liquid present in the container;
b) Triggering the continuous measurement of the values of electrical capacitance between the end of the needle of the suction/discharge device and the assembly consisting of the container, the chassis of the analysis automaton and optionally the liquid present in the container; said value being considered to be the base value B;
c) Triggering the dispensing of the liquid into the container with the aid of the suction/discharge device, so that the container and the needle of the suction/discharge device are in fluidic connection throughout the dispensing;
d) Measuring the period t during which the values of electrical capacitance between the end of the needle of the suction/discharge device and the assembly consisting of the container, the chassis of the analysis automaton and optionally the liquid present in the container are greater than a threshold value S; and
e) Calculating the volume of liquid dispensed into the container by multiplying the value of the period t obtained in step d) by the liquid dispensing flowrate of the suction/discharge device.

2. The method as claimed in claim 1, comprising an additional step c′), subsequent to step c), consisting in moving the suction/discharge device along a vertical axis so as to maintain the distance d between the end of the needle and the surface of the liquid during dispensing.

3. The method as claimed in claim 1, in which the value of d is dependent on the liquid volume to be dispensed into the container.

4. The method as claimed in claim 1, in which the value of the flowrate is a single mean value.

5. The method as claimed in claim 1, in which the value of the flowrate is a value that can vary over the time period t.

6. The method as claimed in claim 1 furthermore comprising an additional step occurring after step b) consisting in determining whether the container contains a residual liquid volume.

7. The method as claimed in claim 6, in which the base value B is compared with a reference value corresponding to the value of capacitance between the end of the needle of the suction/discharge device and the assembly consisting of the container empty of any liquid and the chassis of the analysis automaton.
